(19) United States
(12) Patent Application Publication
(10) Pub. No.: US 2015/0034009 A1
(43) Pub. Date: Feb. 5, 2015

(54) DRAWING DEVICE

(71) Applicant: SEIKO EPSON CORPORATION, Tokyo (JP)

(72) Inventors: Takashi ABE, Sakata-shi (JP); Katsumi SHINKAI, Fujimi-machi (JP); Sadaharu KOMORI, Shiojiri-shi (JP)

(21) Appl. No.: 14/446,808

(22) Filed: Jul. 30, 2014

(30) Foreign Application Priority Data
Aug. 2, 2013 (JP) 2013-161075
Aug. 8, 2013 (JP) 2013-164824
Jun. 9, 2014 (JP) 2014-118419
Jun. 9, 2014 (JP) 2014-118420

(51) Int. Cl. B05C 11/10; B41J 2/175

(52) U.S. Cl. CPC B05C 11/10; B41J 2/17503
USPC 118/712; 118/46

(57) ABSTRACT

A drawing device includes a drawing device main body which has a cartridge setting unit in which a drawing liquid cartridge is set in a detachable manner, and discharges a supplied drawing liquid from the drawing head to perform a drawing process, a chamber room which accommodates the drawing device main body, a booth opening which is provided in the chamber room and causes a drawing liquid cartridge to be received in the chamber room, a transport unit which transports the drawing liquid cartridge between the receiving area and the relay area, and a transfer unit which transfers the drawing liquid cartridge between the relay area and the cartridge setting unit.

### BACKGROUND

1. Technical Field

The present invention relates to a drawing device.

2. Related Art

As this type of drawing device, a droplet discharge device which forms a functional layer such as a color filter of a liquid crystal display device, a light emitting element made of each pixel of an organic EL device, or the like on a substrate by a printing technology (ink jet method) using a functional liquid droplet discharge head which is an ink jet head has been known (refer to JP-A-2007-152259).

The droplet discharge device includes a machine base and a drawing device which perform drawing on a substrate (work) using a functional liquid droplet discharge head provided on the machine base. In addition, the drawing device includes an X-axis table on which a work is mounted, a Y-axis table which is orthogonal to the X-axis table, and a carriage unit which is mounted on the Y-axis table. Then, a plurality of functional liquid droplet discharge heads which discharges a functional liquid are mounted on the carriage unit.

Moreover, the droplet discharge device includes a suction and blowing hood which faces a set substrate, a maintenance device serving for maintenance of a drawing device, and a chamber device which accommodates the drawing device, the suction and blowing hood, and the maintenance device, and maintains an internal atmosphere at a predetermined cleanliness. In addition, the chamber device has a chamber room which accommodates a drawing device, a suction and blowing hood, and a maintenance device, and a clean air supply unit which maintains internal atmosphere in the chamber room at a predetermined cleanliness.

In such a droplet discharge device of a related art, when supplying a functional fluid by an ink cartridge, a replacement of the ink cartridge becomes complicated. For example, when a droplet discharge device is large-sized and a shape of the device is complicated, scaffolds such as stepladders and the like are required in the replacement of the ink cartridge, and there is a need to be careful not to damage the droplet discharge device.

Moreover, in the replacement of the ink cartridge, it is necessary to partially open the chamber room and an atmosphere in the chamber room is possibly contaminated by outside air.

That is, when replacing the ink cartridge, there is a problem that workability including a work environment is lowered.

### SUMMARY

The invention can be realized in the following forms or application examples.

According to this application example, there is provided a drawing device, including a drawing processing unit that includes a cartridge setting unit in which a drawing liquid cartridge capable of supplying a drawing liquid to a drawing head is set in a detachable manner; a transport unit which transports the drawing liquid cartridge between a receiving area which is any area in a vicinity of the drawing processing unit and a relay area which is any area at the cartridge setting unit side; and a transfer unit which transfers the drawing liquid cartridge between the relay area and the cartridge setting unit.

In this case, the drawing liquid cartridge is received in a receiving area in a vicinity of a drawing processing unit, transported from the receiving area to a relay area, and furthermore transferred from the relay area to the cartridge setting unit. In this manner, since the drawing liquid cartridge is set in a cartridge setting unit by using the transport unit and the transfer unit, the drawing liquid cartridge can be simply set regardless of a form of the drawing processing unit or a disposed position of the cartridge setting unit. That is, the drawing liquid cartridge can be simply set and workability can be improved by carrying the drawing liquid cartridge in the receiving area. In addition, a used drawing liquid cartridge can be returned from a cartridge setting unit to the receiving area via the relay area.

It is preferable that the drawing device further include a clean booth which accommodates the drawing processing unit, the transport unit, and the transfer unit, and maintains an internal atmosphere at a predetermined cleanliness; and a booth opening which is provided in the clean booth and communicates with the receiving area.

In this case, the booth opening may have a size capable of receiving the drawing liquid cartridge and opening time for receiving the drawing liquid cartridge can be reduced. Therefore, when the drawing liquid cartridge is received, outside air can be suppressed not to enter into the clean booth and a lowering of cleanliness can be suppressed as much as possible.

According to another application example, there is provided another drawing device, including a drawing processing unit that includes a cartridge setting unit in which a drawing liquid cartridge capable of supplying a drawing liquid to a drawing head is set in a detachable manner; a clean booth which accommodates the drawing processing unit and maintains an internal atmosphere at a predetermined cleanliness; a booth opening which is provided in the clean booth and is intended to receive the drawing liquid cartridge in the clean booth; a transport unit which transports the drawing liquid cartridge received through the booth opening between a receiving area which is any area in a vicinity of the drawing processing unit and a relay area which is any area on the cartridge setting unit side; and a transfer unit which transfers the drawing liquid cartridge between the relay area and the cartridge setting unit.

In this case, the drawing liquid cartridge which is carried in the drawing processing unit is received in the receiving area, transported from the receiving area to the relay area, and furthermore is transferred from the relay area to the cartridge setting unit. Therefore, the booth opening may have a size capable of receiving the drawing liquid cartridge and opening time for receiving the drawing liquid cartridge can be reduced. Therefore, when the drawing liquid cartridge is received, outside air can be suppressed not to enter into the clean booth and a lowering of cleanliness can be suppressed.

It is preferable that the transport unit include a transport mechanism which transports the drawing liquid cartridge; a housing which involves the receiving area and the relay area, and accommodates the transport mechanism; an external opening/closing unit which is provided at an end portion of the booth opening side of the housing, and opens or closes the receiving area with respect to an outside of the clean booth; and an internal opening/closing unit which is provided at an end portion of the transfer unit side of the housing, and opens or closes the relay area with respect to an inside of the clean booth.

In this case, when receiving the drawing liquid cartridge, even if outside air enters into the clean booth, using the external opening/closing unit and the internal opening/closing unit, the outside air can be easily confined in the housing and the possibility that an atmosphere in the clean booth is directly contaminated by the outside air can be reduced.

It is preferable that the external opening/closing unit include an external opening/closing door which opens or closes the receiving area with respect to an outside of the clean booth, and a locking mechanism which locks or unlocks the external opening/closing door in a closed state, and the internal opening/closing unit include an internal opening/closing door which opens or closes the relay area with respect to an inside of the clean booth, and an opening/closing mechanism which opens or closes the internal opening/closing door.

In this case, the internal opening/closing door which cannot be directly contacted by an operator who is outside the clean booth has a structure which can be automatically opened or closed by the opening/closing mechanism, such that workability in an opening/closing operation can be improved. In addition, the external opening/closing door which can be directly contacted has a structure which can be manually opened or closed, such that a function of opening or closing the external opening/closing door can be omitted to simplify a structure of this part. In addition, the external opening/closing door has a structure which can be locked or unlocked in a closed state, such that the external opening/closing door is not opened by mistake and the clean booth can be prevented from being contaminated due to the opening of the external opening/closing door.

It is preferable that the transport unit further include a transport control unit which controls the locking mechanism and the opening/closing mechanism, respectively, and the transport control unit, by a receiving instruction, close the internal opening/closing door, and then release a locking of the external opening/closing door, and, by a transport instruction, lock the external opening/closing door, and then open the internal opening/closing door.

In this case, when receiving the drawing liquid cartridge, since the internal opening/closing door is “closed”, even if outside air enters into the housing, the outside air does not flow to the clean booth. In addition, when transporting the drawing liquid cartridge, the external opening/closing door is closed, and thereby outside air does not enter into the housing.

It is preferable that the transport control unit further control the transport mechanism, transport the drawing liquid cartridge from the relay area to the receiving area between a closing operation of the internal opening/closing door and a locking release of the external opening/closing door by the receiving instruction, and transport the drawing liquid cartridge from the receiving area to the relay area between a locking of the external opening/closing door and an opening operation of the internal opening/closing door by the transport instruction.

In this case, when transporting the drawing liquid cartridge between the relay area and the receiving area, the internal opening/closing door and the external opening/closing door are “closed”, and time in which the external opening/closing door is “open”, that is, time in which outside air enters can be shortened.

Moreover, it is preferable that the relay area be set to be at a position higher than the receiving area in the clean booth, and the transport mechanism ascend or descend the drawing liquid cartridge between the receiving area and the relay area.

In this case, since the receiving area is set to be at a position lower than the relay area in the clean booth, the drawing liquid cartridge can be easily carried in and carried out. Moreover, since the transport mechanism has a structure to ascend or descend the drawing liquid cartridge, a structure of the transport mechanism can be simplified.

It is preferable that the transport mechanism ascend the drawing liquid cartridge up to a position right before a top end of the drawing liquid cartridge reaches the internal opening/closing unit in the relay area.

In this case, the drawing liquid cartridge transported to the relay area does not cause trouble opening or closing the internal opening/closing unit, and the drawing liquid cartridge can be easily transferred between the relay area and the cartridge setting unit.

It is preferable that the drawing liquid cartridge be mounted on a carriage in a state of being set in a set tray, and received in the receiving area, and the transport mechanism receive the set tray from the carriage to start a transportation of the drawing liquid cartridge in an ascending operation, and deliver the set tray to the carriage to complete the transportation of the drawing liquid cartridge in a descending operation.

In this case, the drawing liquid cartridge can be carried in and carried out by the carriage. Moreover, since the transport mechanism transports both the set tray and the drawing liquid cartridge in a form of receiving or delivering the carriage, the drawing liquid cartridge can be simply and stably transported.

It is preferable that the drawing device further include an exhaust unit which exhausts an atmosphere in the housing to an outside of the clean booth.

In this case, outside air which enters into the housing by opening the external opening/closing unit can be exhausted to the outside of the clean booth. Therefore, contamination by dust or outside air carried in with the drawing liquid cartridge hardly occurs in the clean booth.

It is preferable that the exhaust unit include an exhaust air flow path which leads from an end portion of the booth opening side of the housing to an outside of the clean booth; an exhaust fan which is interposed in the exhaust air flow path; and an exhaust air control unit which controls a driving of the exhaust fan, in which the exhaust air control unit drives the exhaust fan when the external opening/closing unit is closed.

In this case, since an atmosphere in the housing flows from a transfer unit side to a booth opening side by a driving of an exhaust fan, the contaminated atmosphere in the housing can be exhausted. At this time, since the external opening/closing unit is closed, entering of outside air by the driving of the exhaust fan can be reduced.

On the other hand, it is preferable that a plurality of types of the drawing liquid cartridges which have different drawing liquids be set in the cartridge setting unit, the plurality of types of drawing liquid cartridges be transported to the relay area in a state of being set in a set tray, and each of the drawing liquid cartridges have a detected portion for detecting a type, the transfer unit include a transfer mechanism which transfers the plurality of types of drawing liquid cartridges; a type detector which is provided in the transfer mechanism and detects a type of the drawing liquid cartridge which is an object to be transferred through the detected portion, and a transfer control unit which controls the transfer mechanism, and the transfer control unit transfer the plurality of types of drawing liquid cartridges based on a result of the detection by the type detector.

In this case, since a detected portion of the drawing liquid cartridge is detected and a plurality of types of drawing liquid cartridges can be transferred based on a result of the detection, the plurality of types of drawing liquid cartridges set on the set tray can be correctly transferred to the cartridge setting unit.

It is preferable that the transfer control unit sort the plurality of types of drawing liquid cartridges based on a type on the set tray before transferring the plurality of types of drawing liquid cartridges.

In this case, the transfer control unit can be divided into a portion related to a transfer of cartridges and a portion related to an alignment of cartridges, and a control system can be simplified as a whole. Therefore, the drawing liquid cartridge can be efficiently transferred.

It is preferable that the drawing processing unit include a table unit which moves a mounted drawing object, and a drawing unit which is provided over the table unit and includes the drawing head and the cartridge setting unit, and perform a drawing process by discharging a drawing liquid from the drawing head while moving the drawing object using the table unit.

In this case, since workability in a replacement of the drawing liquid cartridge is improved, a series of operations in a replacement of the drawing liquid cartridge can be performed in a short period of time.

### BRIEF DESCRIPTION OF THE DRAWINGS

The invention will be described with reference to the accompanying drawings, wherein like numbers reference like elements.

FIG. 1 is an entire perspective view of a drawing device according to an embodiment.

FIG. 2 is an overall plan view of a drawing device according to an embodiment.

FIG. 3 is an X-axis direction side view of the drawing device according to an embodiment.

FIG. 4 is a structure description view of surroundings of a cartridge supply device.

FIGS. 5A to 5C are structure views of a transport unit in a cartridge supply device.

FIG. 6 is a description view of a carriage and a set tray.

FIG. 7 is a flowchart which displays a control method using a transport control unit.

FIG. 8 is a structure view of a transfer unit in the cartridge supply device.

FIG. 9 is a plan view of surroundings of the transfer unit in the cartridge supply device.

FIGS. 10A and 10B are structure views of surroundings of a cartridge setting unit.

FIG. 11 is a flowchart which displays a control method using a transfer control unit.

### DESCRIPTION OF EXEMPLARY EMBODIMENTS

Hereinafter, a drawing device according to an embodiment of the invention will be described referring to the accompanying drawings.

The drawing device is embedded in a manufacturing line of a flat panel display, and forms a light emitting element and the like which are made of each pixel of a color filter of a liquid crystal display device or an organic EL device by using a drawing head into which a drawing liquid including, for example, a special material or a luminescent material is introduced. The drawing device of the embodiment forms a light emitting element of an organic EL device, and is made to supply an expensive drawing liquid configuring a light emitting element to the drawing head through the drawing liquid cartridge.

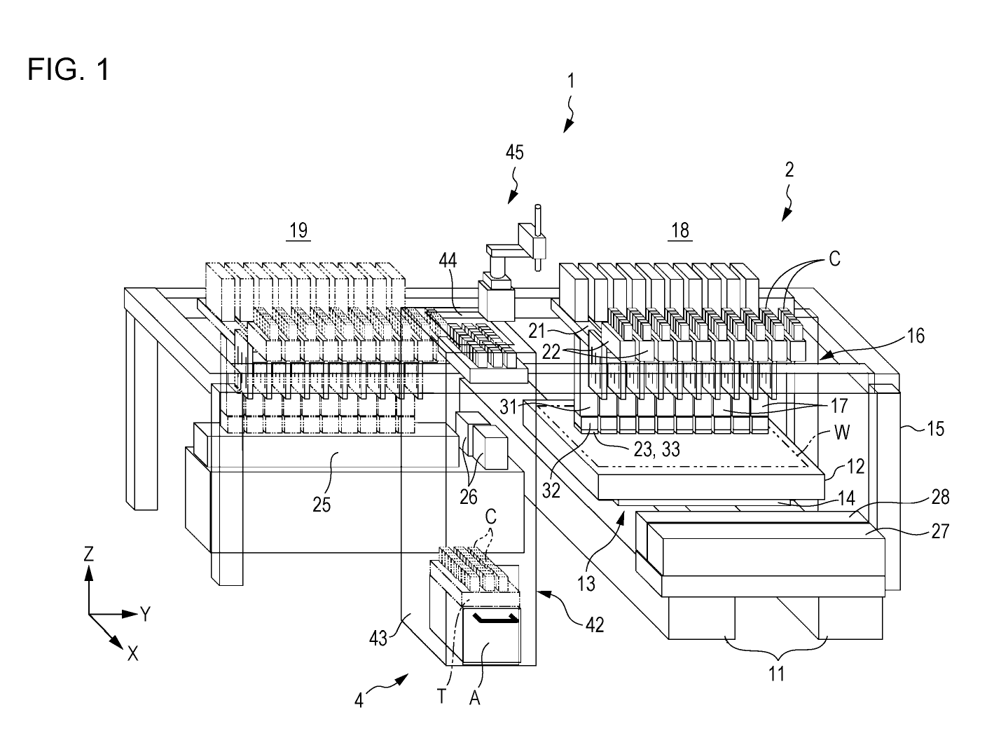

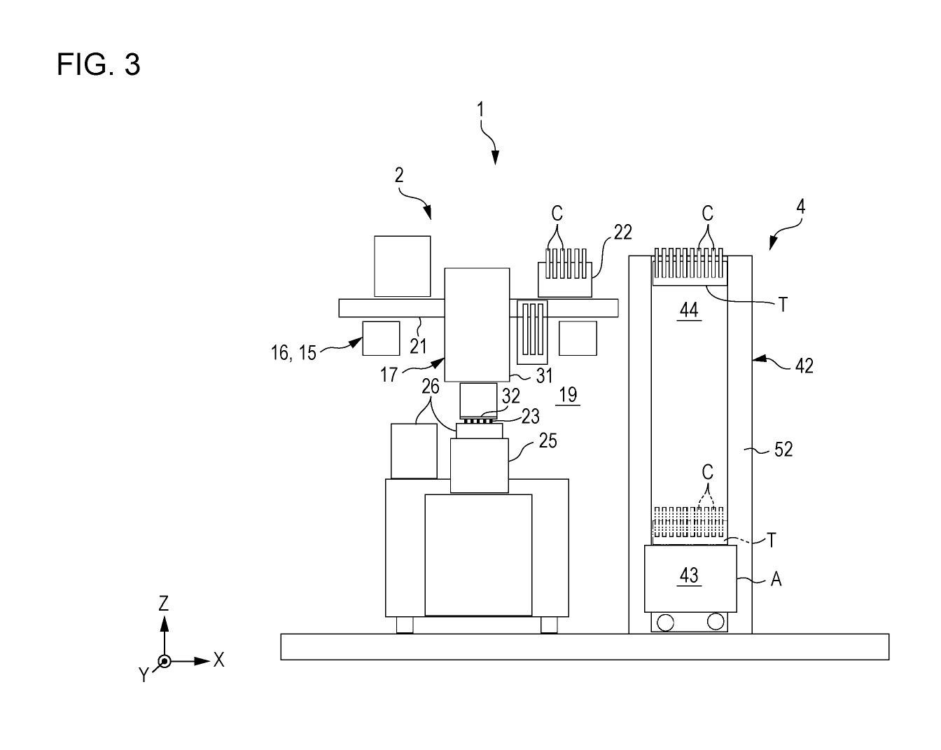

FIGS. 1 to 3 are a perspective view, a plan view, and a side view which schematically display a drawing device 1 of the invention, respectively. As shown in FIGS. 1 to 3, the drawing device 1 includes a drawing device main body 2 (drawing processing unit) which performs predetermined drawing on a work W (substrate: drawing object), a chamber device 3 (clean booth) which accommodates the drawing device main body 2, and a cartridge supply device 4 which supplies a drawing liquid cartridge C to the drawing device main body 2.

A drawing head 23 is mounted on the drawing device main body 2, and is disposed to face the work W. A drawing liquid is discharged toward the work W from the drawing head 23 while performing a main scanning to move the work W in a first direction and a sub-scanning to move the work W in a second direction which is orthogonal to the first direction. The first direction in the main scanning is referred to as a main scanning direction, and the second direction is referred to as a sub-scanning direction. In the embodiment, the main scanning direction is displayed as an X-axis direction, and the sub-scanning direction is displayed as a Y-axis direction. Moreover, a direction which is orthogonal to the X-axis direction and the Y-axis direction is displayed as a Z-axis direction.

The cartridge supply device 4 supplies (substantially, replaces a used drawing liquid cartridge C with a new one) a drawing liquid cartridge C which is brought into the drawing device main body 2 by an operation from outside of the chamber device 3. In addition, the chamber device 3 includes a chamber room 6 which accommodates the drawing device main body 2, and a clean air supply unit 7 which adjusts cleanliness, temperature, or the like of the atmosphere in the chamber room 6.

The drawing device main body 2 includes an X-axis support base 11 which extends in the X direction and is configured to have a stone surface plate, an X-axis table 13 which is provided on the X-axis support base 11 and moves the work W set to be absorbed on a set stage 12 in the X direction (main scanning direction), a newline axis table 14 which is interposed between the X-axis table 13 and the set stage 12, and moves the work W in the Y direction (sub-scanning direction), a Y-axis support base 15 of a frame structure stretched in the Y-axis direction so as to span the X-axis table 13, a Y-axis table 16 which is provided on the Y-axis support base 15, and extends in the Y-axis direction, and a plurality (for example, ten) of carriage units 17 which are configured to be moveable between a drawing area 18 and a maintenance area 19 by the Y-axis table 16.

Each carriage unit 17 is suspended on a bridge plate 21 extending in the X-axis direction, and is supported by the Y-axis table 16 through the bridge plate 21. Each bridge plate 21 also functions as a Y-axis slider of the Y-axis table 16, and a plurality of carriage units 17 are configured to be moveable in the Y-axis direction individually or as a whole through each bridge plate 21 by the Y-axis table 16.

In addition, the cartridge setting unit 22 is provided on each bridge plate 21, and a plurality of drawing liquid cartridges C are set in the cartridge setting unit 22. Then, a plurality of drawing heads 23 are mounted on each carriage unit 17, and a drawing liquid is supplied from a plurality of drawing liquid cartridges C set in a corresponding cartridge setting unit 22 to these drawing heads 23. A “table unit” mentioned in the claims is configured by the X-axis table 13 and the newline axis table 14, and a “drawing unit” is configured to have the Y-axis table 16, the carriage unit 17, the bridge plate 21, and the cartridge setting unit 22.

Moreover, the drawing device main body 2 includes a suction unit 25 and a wiping unit 26 (two for alternating operations) provided in a maintenance area 19 as a maintenance system of the drawing head 23, and includes a flushing unit 27 and an inspection unit 28 mounted on the X-axis table 13. A suction unit 25 forcibly sucks the drawing liquid from the drawing head 23 (elimination of nozzle clogging), and the wiping unit 26 wipes a nozzle surface of the drawing head 23 (prevention of flight bending). Moreover, the flushing unit 27 allows the drawing liquid to be discarded and discharged from the drawing head 23, and the inspection unit 28 discharges the drawing liquid from a nozzle of the drawing head 23 to an inspection sheet as a droplet, and inspects discharge performance (a discharge amount, discharge position accuracy, and the like) of the drawing head 23 by inspecting a shape of a droplet which landed on the inspection sheet and a landing position.

The X-axis table 13 moves the work W in the X-axis direction by a motor driven by a linear motor, and performs a discharge drive of the drawing head 23 and a main scanning on the work W. In the same manner, a newline axis table 14 performs a sub-scanning on the work W by the motor driven by the linear motor. That is, drawing using the drawing liquid is performed on the work W by the main scanning and the sub-scanning. The Y-axis table 16 not only moves the drawing head 23 to a predetermined drawing start position when performing drawing through each carriage unit 17, but also moves the drawing head 23 to the maintenance area 19 when performing maintenance by a motor driving using a linear motor. Furthermore, the Y-axis table 16 moves the drawing head 23 (carriage unit 17) to the maintenance area 19 when replacing the drawing liquid cartridge C (the details will be described below).

Each carriage unit 17 includes a vertically-provided member 31 supported by the bridge plate 21, and a head unit 32 mounted onto a lower end of the vertically-provided member 31. A plurality of drawing heads 23 are mounted on the head unit 32 so as to be supported by a head plate 33. Then, a plurality of types of drawing liquids, for example, per color and the like are supplied from the above-mentioned drawing liquid cartridge C to the plurality of drawing heads 23. That is, the plurality of drawing heads 23 corresponding to the plurality of types of drawing liquids are mounted on each carriage unit 17, and accordingly, the plurality of drawing liquid cartridges C are set in the cartridge setting unit 22 (the details will be described).

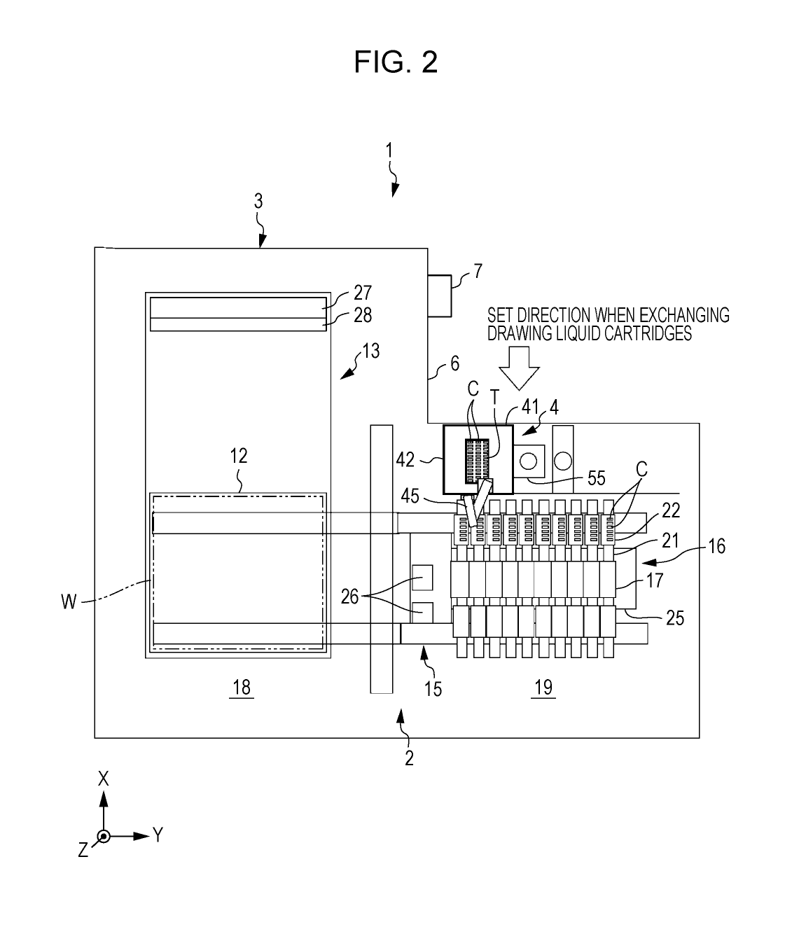

As shown in FIG. 2, the chamber device 3 includes the chamber room 6 configured to have a clean booth of a prefab form, and a clean air supply unit 7 for constantly adjusting cleanliness, temperature, or the like of the atmosphere in the chamber room 6. Even if the details are not illustrated, the clean air supply unit 7 has a cooling coil, a heater, and an air blower, and has a HEPA filter embedded in at least the drawing area 18 and the maintenance area 19 among an entire ceiling of the chamber room 6.

In the chamber device 3, the clean air supply unit 7 supplies air or exhausts air to or from the chamber room 6 all the time (ventilation at all times). That is, the supplied air flows in a down flow from a ceiling side of the chamber room 6, and the atmosphere in the chamber room 6 is maintained at a predetermined temperature and a predetermined cleanliness. The atmosphere in the chamber room 6 is exhausted from an exhaust port provided at a bottom of the chamber room 6 to external exhaust equipment (vacuum suction) (not illustrated).

The cartridge supply device 4 transports the drawing liquid cartridge C which is provided in the maintenance area 19 and is brought in from outside of the chamber room 6 once, to the vicinity of the cartridge setting unit 22, and transfers the drawing liquid cartridge C from the transport position to the cartridge setting unit 22 (cartridge replacement). That is, the cartridge supply device 4 replaces the drawing liquid cartridge C which is used up (used) in the cartridge setting unit 22 with a new drawing liquid cartridge C.

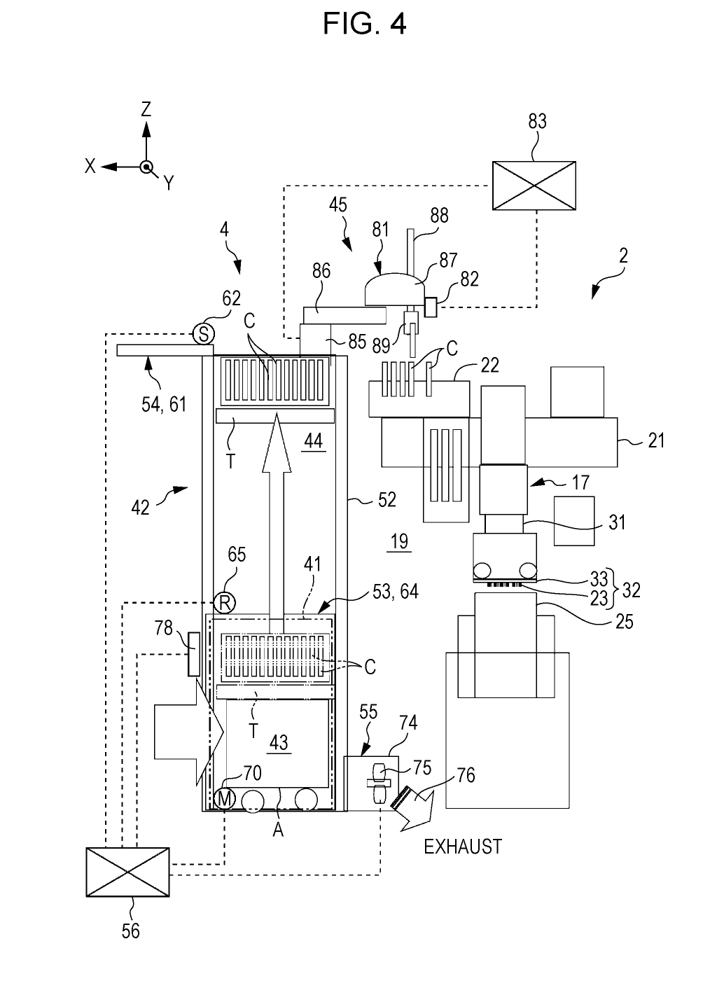

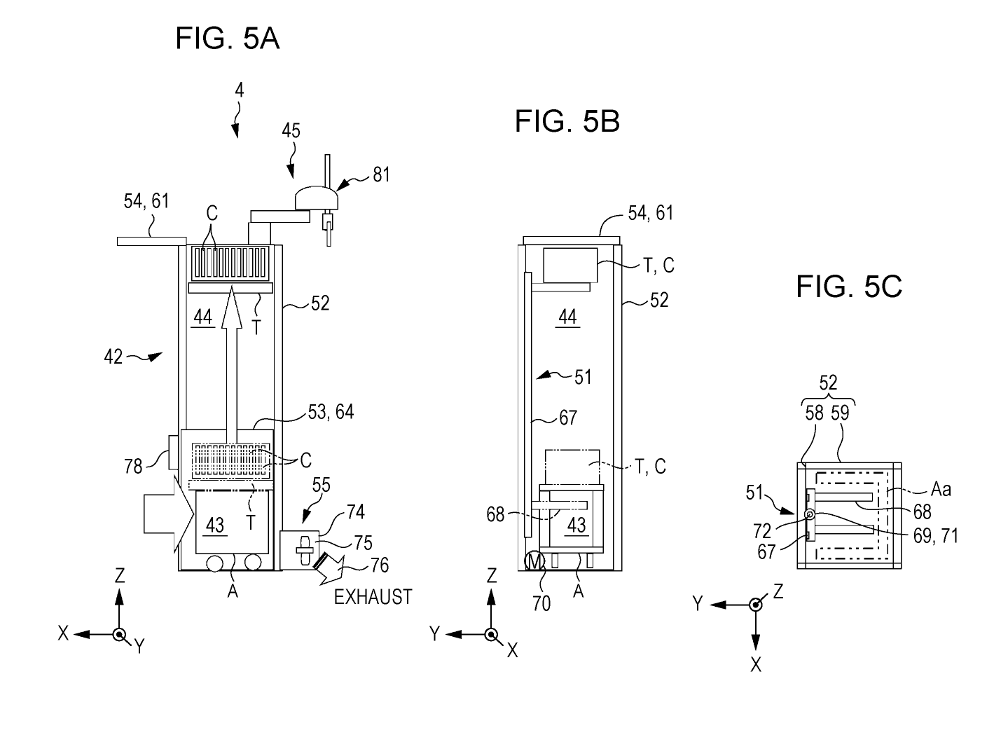

Here, referring to FIGS. 2 to 5A, 5B, and 5C, a cartridge supply device 4 according to an embodiment will be described in detail. FIG. 4 is a side view of the cartridge supply device 4 when viewed from a drawing area 18 side toward the maintenance area 19. FIGS. 5A and 5B are side views of the cartridge supply device 4, and FIG. 5C is a plan view which shows a configuration of the transport mechanism 51.

As shown in both views, the cartridge supply device 4 is disposed along a side wall of the chamber room 6 in the maintenance area 19 in the chamber room 6. The cartridge supply device 4 includes a booth opening 41 for receiving the drawing liquid cartridge C into the chamber room 6, a transport unit 42 which transports the drawing liquid cartridge C which is received through the booth opening 41 in a vertical direction between a receiving area 43 and a relay area 44 in the vicinity of the cartridge setting unit 22, and a transfer unit 45 which transfers the drawing liquid cartridge C between the relay area 44 and the cartridge setting unit 22.

In other words, old and new drawing liquid cartridges C are replaced by a transportation between the receiving area 43 and the relay area 44 by the transport unit 42 and a transfer between the relay area 44 and the cartridge setting unit 22 by the transfer unit 45 in the cartridge supply device 4. A transfer to the cartridge setting unit 22 of the drawing liquid cartridge C includes a position decision setting and a flow path connection of the drawing liquid cartridge C (the details will be described below).

As shown in FIGS. 4 and 5A to 5C, the transport unit 42 includes a transport mechanism 51 which transports the drawing liquid cartridge C in a vertical direction (Z-axis direction), a housing 52 which involves the receiving area 43 at a bottom thereof and the relay area 44 at a top thereof, and accommodates the transport mechanism 51, an external opening/closing unit 53 which is provided at a lower end portion side surface of the housing 52, and opens or closes the receiving area 43 with respect to an outside of the chamber room 6, and an internal opening/closing unit 54 which is provided at a top end portion of the housing 52, and opens or closes the relay area 44 with respect to an inside of the chamber room 6.

In addition, the transport unit 42 includes an exhaust unit 55 which exhausts an atmosphere in the housing 52 to the outside of the chamber room 6, and a transport control unit 56 which controls the transport mechanism 51, the external opening/closing unit 53, the internal opening/closing unit 54, and the exhaust unit 55. The transport control unit 56 includes “transport control unit” and “exhaust air control unit” mentioned in the claims.

The housing 52 includes a housing frame 58 which is configured to have a channel material and the like, and a plurality of panel materials 59 which is mounted onto the housing frame 58 from outside in a very close manner and configures a surrounding wall (refer to FIG. 5C). The housing 52 is formed in a rectangular box shape which extends from a floor of the chamber room 6 to a position reaching a height of the cartridge setting unit 22. The relay area 44 for transferring the drawing liquid cartridge C is configured at a top end portion of the housing 52, and the internal opening/closing unit 54 in a shutter form which opens or closes the relay area 44 is provided at the top end portion of the housing 52.

On the other hand, the receiving area 43 for bringing in or taking out the drawing liquid cartridge C is configured at a lower end portion of the housing 52, and the external opening/closing unit 53 in a hinged door form which opens or closes the receiving area 43 is provided at a lower end portion side surface of the housing 52. The lower end portion side surface of the housing 52 at which the external opening/closing unit 53 is provided is close to the above-mentioned booth opening 41 and the two communicate with each other. Then, the drawing liquid cartridge C mounted on the carriage A from the portion is carried into the receiving area 43 or carried out from the receiving area 43. The booth opening 41 and the receiving area 43 communicate with each other in a very close manner.

The internal opening/closing unit 54 opens or closes the relay area 44 with respect to the inside of the chamber room 6, and includes an internal shutter 61 (internal opening/closing door) which opens or closes a top end of the housing 52, and an internal air cylinder 62 (opening/closing mechanism) which opens or closes the internal shutter 61 (refer to FIG. 4). The details will be described below; however, the internal shutter 61 is generally opened, but is closed when the carriage A brings in or takes out the drawing liquid cartridge C in the receiving area 43.

The external opening/closing unit 53 opens or closes the receiving area 43 with respect to the outside of the chamber room 6, and includes the external opening/closing door 64 which opens or closes the lower end portion side surface of the housing 52 in a half-opened hinged door form, and an electromagnetic locking mechanism 65 (locking mechanism) which is locked or unlocked with the receiving area 43 closed by the external opening/closing door 64 (refer to FIG. 4). The details will be described below. The external opening/closing door 64 is generally closed and locked, but the locking is released and the door 64 is manually opened when carrying in and carrying out the drawing liquid cartridge C in the receiving area 43.

The transport mechanism 51 includes a pair of ascending or descending guides 67 fixed to an inside of the housing frame 58, a transport fork 68 which is slidably mounted onto the pair of ascending or descending guides 67, a lead screw mechanism 69 which ascends or descends the transport fork 68, and a transport motor 70 which operates the lead screw mechanism 69 (refer to FIGS. 5B and 5C). The lead screw mechanism 69 is made of a female screw portion 71 which is provided in the transport fork 68 and a lead screw 72 (ball screw) which is screwed into the female screw portion 71 and extends in parallel to the ascending or descending guide 67, and the transport motor 70 is connected to the lead screw 72. The transport motor 70 forwardly or reversely drives and the lead screw 72 forwardly or reversely rotates, and thereby the transport fork 68 ascends or descends through the female screw portion 71.

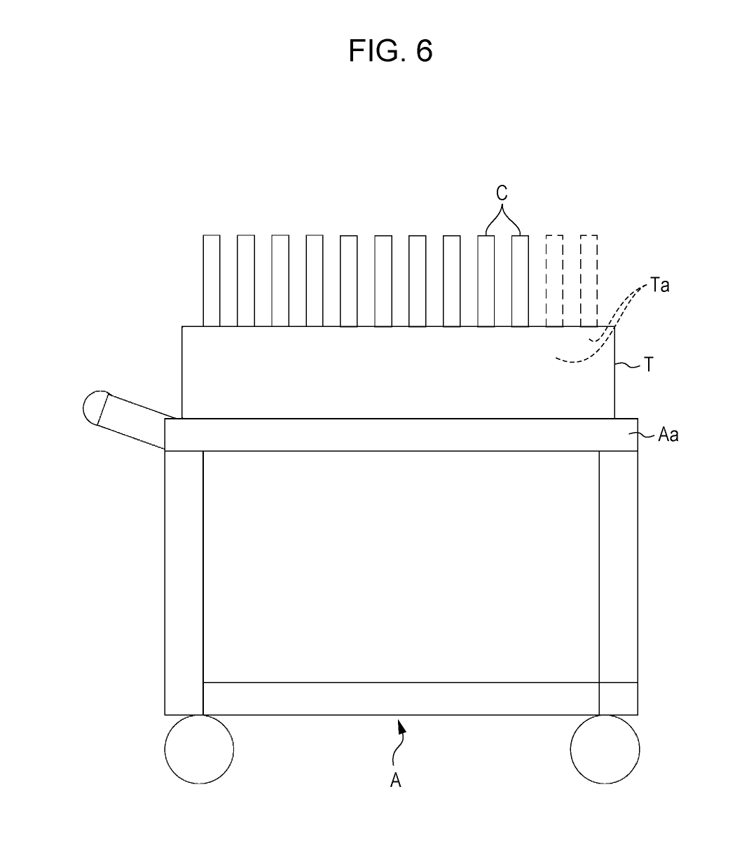

As shown in FIGS. 5A to 5C and 6, the drawing liquid cartridge C carried in the chamber room 6 is mounted on the carriage A with a caster, and is received in the chamber room 6 together with the carriage A. On a top surface of the carriage A, a placement frame Aa of a “U” shape is provided (refer to FIG. 5C), and a set tray T is mounted on the placement frame Aa. Then, a plurality of drawing liquid cartridges C on the set tray T are mounted on an individual setting unit Ta of the set tray T, respectively.

Therefore, the transport mechanism 51 (transport fork 68) receives the set tray T from the carriage A to start a transportation of the drawing liquid cartridge C in a beginning of an ascending operation, and delivers the set tray T to the carriage A to complete the transportation of the drawing liquid cartridge C in a beginning of a descending operation.

Specifically, the transport fork 68 positioned at a descending end is positioned in the carriage A (refer to FIG. 5B) and starts ascending to pass through the placement frame Aa of the carriage A, thereby receiving the set tray T on the placement frame Aa to be pushed up from the lower side and ascending the set tray. Moreover, the transport fork 68 in the descending process passes through the placement frame Aa of the carriage A, thereby delivering the set tray T to be placed on the placement frame Aa from an upper side and descending the set tray to a descending end position. On the other hand, the transport fork 68 which is ascending stops at a predetermined ascending end position in the relay area 44. The ascending end position is set to be a position in which a top end of the mounted drawing liquid cartridge C reaches the vicinity of the internal opening/closing unit 54, that is, a very limit position in which a top end of the drawing liquid cartridge C does not interfere with the closed internal shutter 61 (refer to FIG. 5B).

As shown in FIGS. 4 and 5A to 5C, the exhaust unit 55 includes an exhaust chamber 74 which communicates with the housing 52, an exhaust fan 75 which is provided in the exhaust chamber 74, and an exhaust duct 76 which is connected to the exhaust chamber 74. The exhaust chamber 74 communicates with a lower end portion side surface of the housing 52, and when the exhaust fan 75 provided in the exhaust chamber 74 drives, an atmosphere in the housing 52 flows in a down flow from a top to a bottom to be exhausted to the outside (the above-mentioned exhaust equipment) of the chamber room 6 through the exhaust duct 76. In this case, an exhaust of the atmosphere in the housing 52 substantially replaces the atmosphere in the housing 52 with an atmosphere in the chamber room 6 (ventilation). “Exhaust air flow path” mentioned in the claims is configured to have the exhaust chamber 74 and the exhaust duct 76.

The transport control unit 56 controls the transport mechanism 51, the external opening/closing unit 53, the internal opening/closing unit 54, and the exhaust unit 55 as described above. Specifically, the transport control unit 56 controls the transport motor 70 of the transport mechanism 51, and ascends or descends the transport fork 68. Moreover, the transport control unit 56 locks or unlocks the receiving area 43 in a closed state using the external opening/closing door 64 through the electromagnetic locking mechanism 65 of the external opening/closing unit 53, and opens or closes the internal shutter 61 through the internal air cylinder 62 of the internal opening/closing unit 54. Furthermore, the transport control unit 56 turns on or off an exhaust fan 75 of the exhaust unit 55 and performs an exhaust operation and a non-exhaust operation in the housing 52. An operation panel 78 of the transport control unit 56 is provided on a side of the booth opening 41 (refer to FIG. 4), and is operable by an operator from the outside.

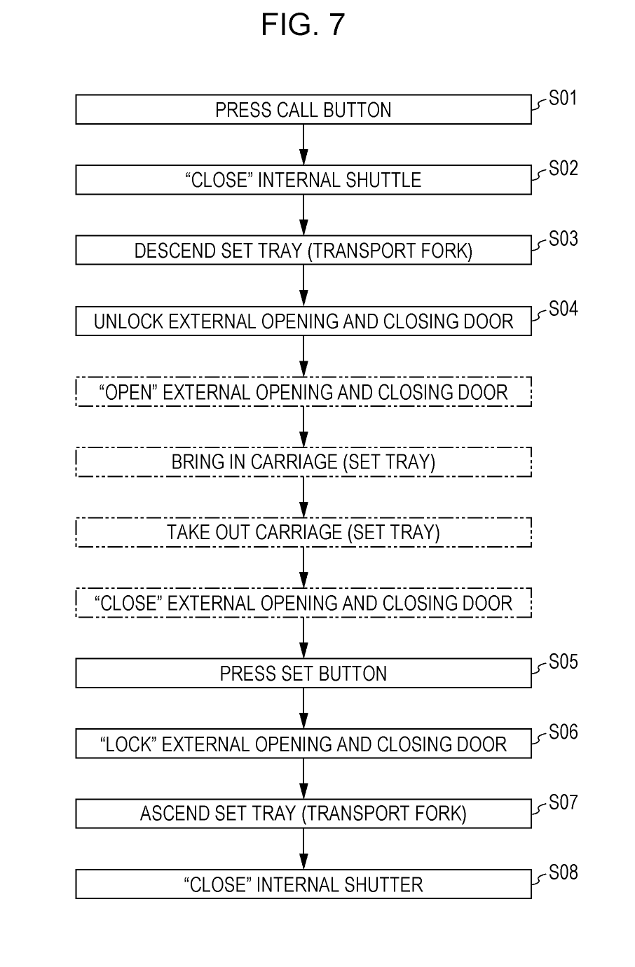

Here, referring to flowcharts in FIGS. 4, 5A to 5C and 7, a method of manufacturing the transport unit 42 using the transport control unit 56 will be described.

A control sequence starts from a state where the transport fork 68 is at an ascending end position, the internal shutter 61 is at an “open” position, the external opening/closing door 64 is closed and locked, that is, at a “closed” position, and an empty carriage A is in the receiving area 43. A plurality of drawing liquid cartridges C which are used up (used) are mounted on the transport fork 68 at an ascending end position through the set tray T.

Outside the chamber room 6, an operator who prepares a plurality of drawing liquid cartridges C to be replaced starts an operation of the transport unit 42 by pressing a call button of the operation panel 78. When the call button is pressed (S01: receiving instruction), the internal shutter 61 is first closed (S02), the transport fork 68 subsequently descends, and a plurality of drawing liquid cartridges C are delivered to the carriage A together with the set tray T (S03). Subsequently, the electromagnetic locking mechanism 65 releases a locking of the external opening/closing door 64 (S04). In this state, a control operation of the transport unit 42 is completed once. Here, the operator opens the external opening/closing door 64, and carries out (draw out) the carriage A and the drawing liquid cartridge C from the receiving area 43. Then, the operator carries a new drawing liquid cartridge C together with the carriage A in the receiving area 43.

After carrying the carriage A in the receiving area 43 and closing the external opening/closing door 64, the operator presses a set button of the operation panel 78 (S05: transport instruction). Accordingly, the transport unit 42 starts an operation again. When the set button is pressed, the external opening/closing door 64 is closed and locked (S06), and subsequently the transport fork 68 starts ascending. The transport fork 68 which is ascending receives the set tray T from the carriage A and further ascends to an ascending end position (S07). That is, the transport fork 68 transports a plurality of drawing liquid cartridges C to the relay area 44. Here, the internal shutter 61 is automatically opened by the internal air cylinder 62 (S08). Accordingly, the plurality of drawing liquid cartridges C of the relay area 44 become in a transfer standby state by the transfer unit 45.

On the other hand, an exhaust fan 75 of the exhaust unit 55 is basically ON all the time. However, since the exhaust fan sucks outside air when the external opening/closing door 64 is opened, the transport control unit 56 turns off the exhaust fan 75 when the external opening/closing door 64 is opened, that is, only when the electromagnetic locking mechanism 65 is in an unlocking state. Even if outside air enters into the housing 52 by an opening of the external opening/closing door 64 by an operator, since the housing 52 is closed by the internal shutter 61, the outside air remains in the housing 52.

Then, since the exhaust fan 75 starts driving right after closing the external opening/closing door 64 (closed and locked state), the outside air which entered is exhausted with dust which is brought in by being attached to the carriage A, the drawing liquid cartridge C, or the like from the housing 52. Accordingly, when the internal shutter 61 is opened and the drawing liquid cartridge C is in a transfer standby state, the housing 52 returns to having an equivalent cleanliness to the chamber room 6. In the embodiment, the external opening/closing door 64 is configured to be manually opened or closed; however, the external opening/closing door may be configured to be automatically opened or closed.

Next, the transfer unit 45 will be described referring to FIGS. 4, 8, and 9.

As described above, a plurality of drawing heads 23 corresponding to a plurality of types of drawing heads 23, for example, per color and the like are mounted on each carriage unit 17, and accordingly a plurality of drawing liquid cartridges C are set in the cartridge setting unit 22 (refer to FIG. 4). In this case, the drawing liquid cartridge C is set as a set of two in the cartridge setting unit 22 for each drawing liquid type. That is, when one of the drawing liquid cartridges C is used up, the drawing device main body 2 automatically switches to the other drawing liquid cartridge C.

Therefore, the transfer unit 45 of the embodiment removes the drawing liquid cartridge C which is used up (used) and supplies a new drawing liquid cartridge C (replace) between the set tray T which is in a standby state in the relay area 44 and the cartridge setting unit 22. Then, a timing of replacing the drawing liquid cartridge C is managed at a drawing device main body 2 side, and a first drawing liquid cartridge C which is used up earlier is replaced before a second drawing liquid cartridge C is used up in an entire cartridge setting unit 22.

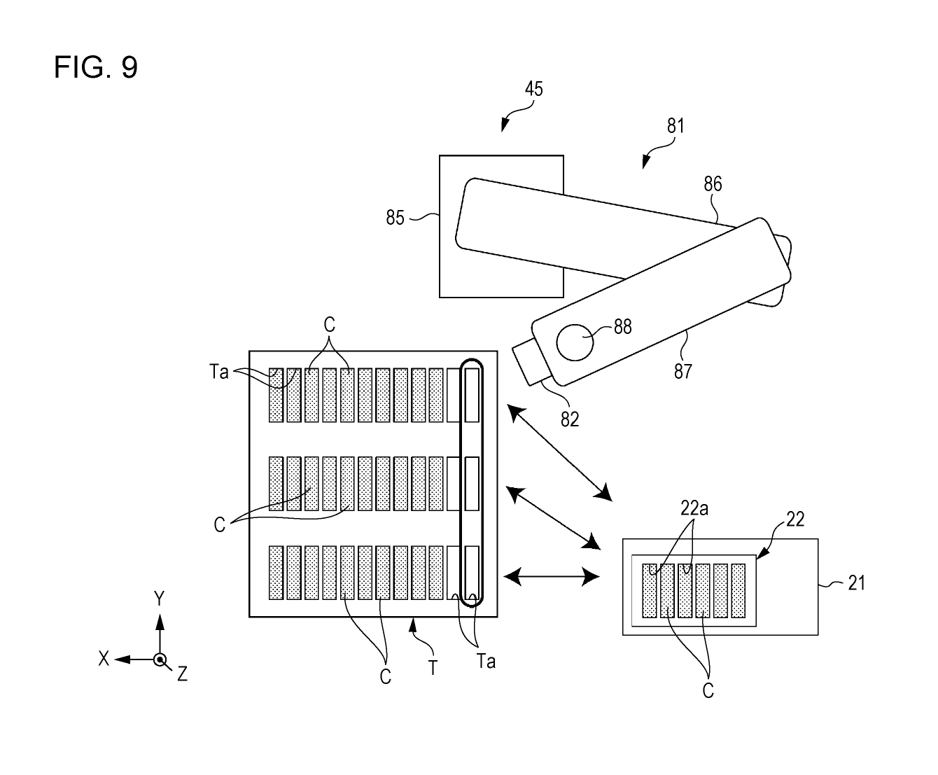

In the embodiment, color filters such as a red color (R), a green color (G), and a blue color (B), or three types of drawing liquids for forming a light emitting layer (a plurality of types of drawing liquids) are assumed. In addition, ten carriage units 17 are provided. Accordingly, two drawing liquid cartridges C corresponding to each of, for example, R, G, and B, for a total of six, are mounted on each of the ten cartridge setting units 22. In addition, ten of each of the three types of drawing liquid cartridges C corresponding to R, G, and B, 30 in total, are mounted on the set tray T (all refer to FIG. 9).

The transfer unit 45 includes a transfer mechanism 81 of a robot configuration to transfer a plurality (a plurality of types) of drawing liquid cartridges C one by one, a type detector 82 which is provided in the transfer mechanism 81 and detects a type of the drawing liquid cartridge C which is an object to be transferred through a detected portion, and a transfer control unit 83 which controls the transfer mechanism 81 based on a result of the detection of the type detector 82 (refer to FIG. 4).

On the other hand, as shown in FIG. 9, in each cartridge setting unit 22 which the transfer unit 45 accesses, two for each color (type), six drawing liquid cartridges C in total, are mounted to six aligned individual mounting set units 22a. Moreover, three rows for each color (type) are set in the set tray T, and ten drawing liquid cartridges C for each color (type) are set in each of 12 individual setting units Ta. Therefore, in this case, the drawing liquid cartridge C is not set in the set tray T, and two empty individual setting units Ta are present for each row.

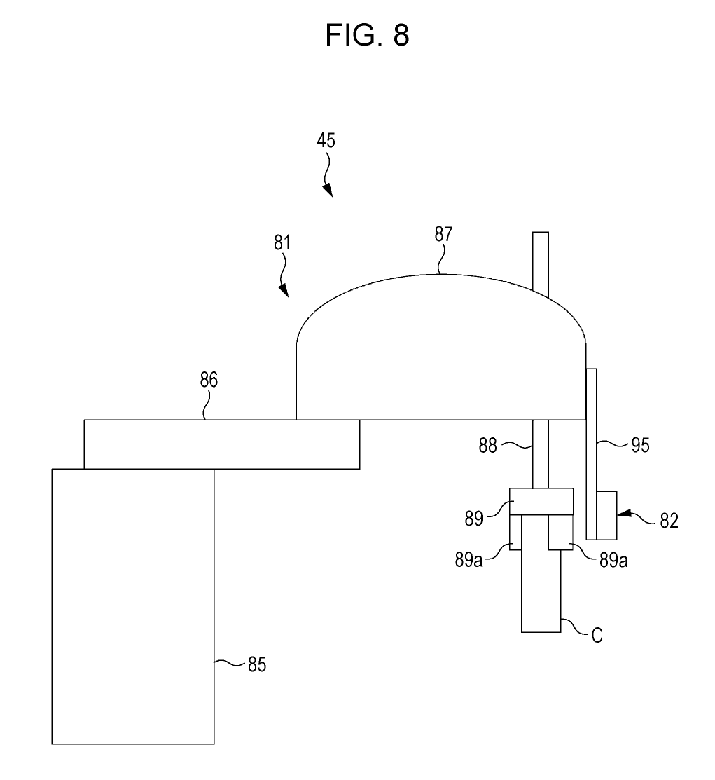

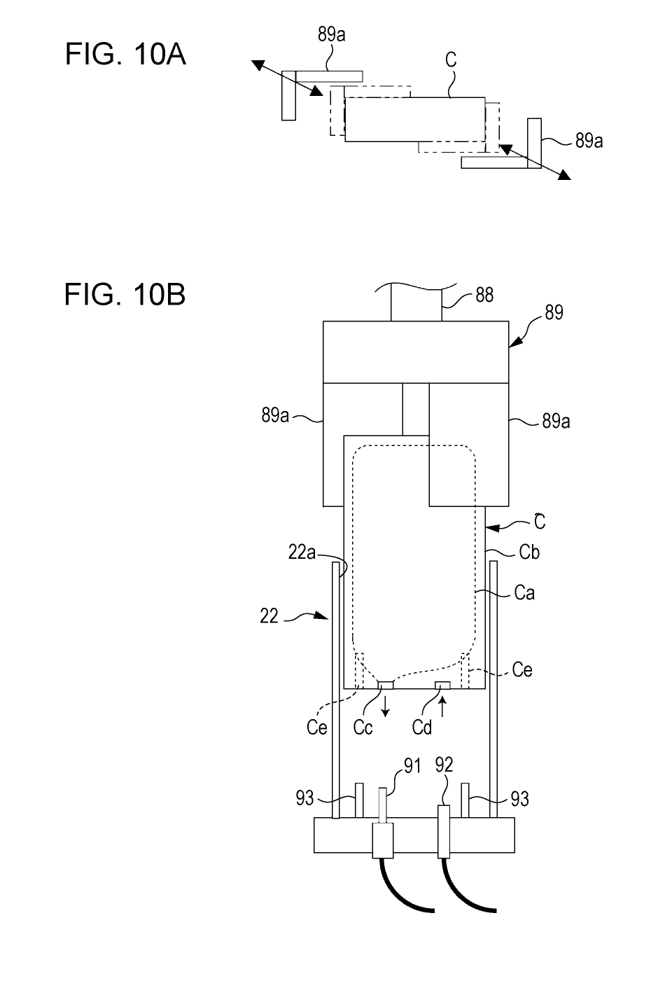

As shown in FIG. 8, the transfer mechanism 81 is configured to have a so-called scalar robot, and includes a robot base 85, a first horizontal arm 86 which is mounted onto the robot base 85 in a turnable manner, a second horizontal arm 87 which is mounted onto a front end portion of the first horizontal arm 86 in a turnable manner, a vertical arm 88 which is mounted onto a front end portion of the second horizontal arm 87 in a vertically movable manner, and a gripping head 89 which is mounted to a front end of the vertical arm 88. The gripping head 89 includes a pair of gripping pieces 89a having a cross-section of an “L” shape, and a top end portion of the drawing liquid cartridge C is made to be diagonally gripped by the pair of gripping pieces 89a (refer to FIG. 10A).

On the other hand, as shown in FIG. 10B, each drawing liquid cartridge C is configured to accommodate a drawing liquid container Ca of a pack form in a sealed case Cb made of resin. A drawing liquid supply port Cc which communicates with the drawing liquid container Ca, and an air introduction port Cd which communicates with a gap between the drawing liquid container Ca and the sealed case Cb are provided in the drawing liquid cartridge C. A drawing liquid is supplied from the drawing liquid supply port Cc to the drawing head 23 by introducing compressed air from the air introduction port Cd and pressurizing the drawing liquid container Ca. Moreover, a pair of engaging concave portions Ce for deciding a position is provided in the sealed case Cb. Furthermore, not illustrated, a two dimensional code (QR code (registered trademark)) which is the above-mentioned detected portion is attached to a top surface of the sealed case Cb.

On the other hand, a drawing liquid introduction port 91 corresponding to the drawing liquid supply port Cc, and an air supply port 92 corresponding to the air introduction port Cd are provided in each individual mounting set unit 22a of the cartridge setting unit 22. Furthermore, a pair of engaging convex portions 93 corresponding to the pair of engaging concave portions Ce of the sealed case Cb is provided in each individual mounting set unit 22a. The transfer mechanism 81 horizontally moves the drawing liquid cartridge C gripped by the gripping head 89 up to right above the individual mounting set unit 22a, and then causes the drawing liquid cartridge to descend to be mounted (set) on the individual mounting set unit 22a. Accordingly, the engaging concave portion Ce is engaged with the engaging convex portion 93 and the drawing liquid supply port Cc is bonded (flow path connection) with the drawing liquid introduction port 91, and the air introduction port Cd is bonded with the air supply port 92, respectively.

A type detector 82 of the transfer unit 45 is configured to have a code reader which reads a two-dimensional code of the drawing liquid cartridge C. The type detector 82 is mounted at a front end of the second horizontal arm 87 through a supporting member 95 so as to be positioned in the vicinity of the gripping head 89 (refer to FIG. 8). In the two-dimensional code, at least a type of the drawing liquid cartridge C is encoded, and the type detector 82 reads a type of the drawing liquid cartridge C while the transfer control unit 83 controls the transfer mechanism 81 based on a result of the reading.

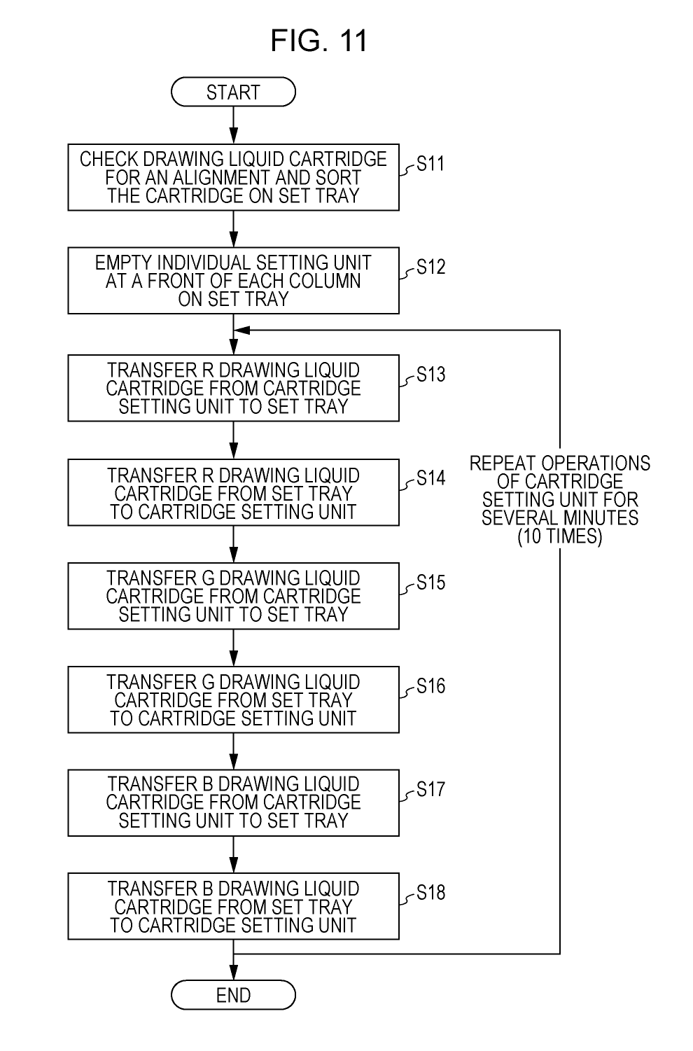

Here, a method of controlling the transfer unit 45 by the transfer control unit 83 will be described referring to FIGS. 4, 9, and 11.

Here, in the relay area 44, ten new drawing liquid cartridges C for each color are mounted on the set tray T in a standby state, and one (three of six) used drawing liquid cartridge C for each color is mounted on any one cartridge setting unit 22. A control start by the transfer control unit 83 may set a control completion of the transport control unit 56 to be a trigger, or separately, may set an instruction from an operator to be a trigger.

The transfer control unit 83 first checks whether or not the drawing liquid cartridges C on the set tray T are aligned for each color, and empties an individual setting unit Ta for each color (each row) positioned at a furthest front side (cartridge setting unit 22 side) of the set tray T. That is, the transfer control unit 83 drives the transfer mechanism 81 and performs read scanning on a plurality of drawing liquid cartridges C for each row using the type detector 82, thereby checking whether or not the drawing liquid cartridge C is correctly set (S11). When each row of the drawing liquid cartridge C is not correctly set for each color (type), the drawing liquid cartridges C are sorted by using the empty individual setting unit Ta (S11).

At the same time, in order to empty the individual setting unit Ta of each color (each row) positioned at the furthest front side, movement of the drawing liquid cartridge C is performed (S12). A process of “S12” may be specified to be first performed, and a process of “S11” may be specified to be performed later.

In this manner, when a preparation at a set tray T side is completed, the transfer mechanism 81 faces the cartridge setting unit 22. Here, for example, R used drawing liquid cartridge C is pulled out from the cartridge setting unit 22, and is transferred from a front of the set tray T to a first (the furthest front) empty individual setting unit Ta (S13). Subsequently, the drawing liquid cartridge C of a second individual setting unit Ta is gripped and is transferred from the front of the set tray T to the empty individual mounting set unit 22a of the cartridge setting unit 22 to be mounted thereon (S14).

Then, such an operation (replacement) is repeated for a G drawing liquid cartridge C and a B drawing liquid cartridge C. That is, a transfer from the cartridge setting unit 22 of the G drawing liquid cartridge C to the set tray T (S15), and a transfer from the set tray T of the G drawing liquid cartridge C to the cartridge setting unit 22 (S16) are performed. In addition, a transfer from the cartridge setting unit 22 of the B drawing liquid cartridge C to the set tray T (S17), and a transfer from the set tray T of the B drawing liquid cartridge C to the cartridge setting unit 22 (S18) are performed.

The above operations are performed between the cartridge setting unit 22 and the set tray T for each ten carriage units 17. At this time, the drawing liquid cartridge C is transferred so that a position of the individual setting unit Ta which becomes empty on the set tray T sequentially moves to a rearward side. That is, the drawing liquid cartridge C for each row is replaced from a front side of the set tray T. Accordingly, even if dripping occurs on an old drawing liquid cartridge C at a time of transferring, a new drawing liquid cartridge C is not contaminated. It is preferable that the cartridge setting unit 22 of an operation target come to the same position in the vicinity of the replay area 44 all the time by sequentially sending ten carriage units 17 using the Y-axis table 16. In this manner, when replacement of the drawing liquid cartridge C in the cartridge setting unit 22 is completed for each ten carriage units 17, the transfer mechanism 81 returns to a home position, and the set tray T of the relay area 44 is in a standby state to be taken out.

As described above, according to the embodiment, the cartridge supply device 4 which includes a transport unit 42 that transports the drawing liquid cartridge C between the receiving area 43 and the relay area 44, and a transfer unit 45 which transfers the drawing liquid cartridge C between the relay area 44 and the cartridge setting unit 22 is included in the chamber room 6 which accommodates the drawing device main body 2, such that it is possible to replace and to set a used drawing liquid cartridge C in the cartridge setting unit 22 by an operation from outside of the chamber room 6. Moreover, compared to when bringing the set tray T in the chamber room 6 by an operator, it is possible to reduce a size of the booth opening 41 for receiving the drawing liquid cartridge C or the external opening/closing unit 53 to an extent of a size of the carriage A, and to reduce opening time thereof to an extent of time required to put the carriage A in and out.

Therefore, when receiving the drawing liquid cartridge C, outside air is suppressed not to enter into the chamber room 6, thereby it is possible to suppress a lowering of cleanliness in the chamber room 6 as much as possible. In addition, the housing 52 is provided in the transport unit 42, the drawing liquid cartridge C is transported in the housing 52, and an atmosphere in the housing 52 is intended to be appropriately exhausted to the outside of the chamber room 6. Therefore, it is possible to prevent the lowering of cleanliness in the chamber room 6 even in this respect.

In this manner, since the drawing device 1 can perform a replacement of the drawing liquid cartridge C while maintaining the cleanliness in the chamber room 6 in a substantially constant manner, it is possible to efficiently perform a series of operations in a replacement of the drawing liquid cartridge C in a short period of time. Therefore, it is possible to reduce downtime of a drawing process in the drawing device main body 2, and to reduce cycle time of the drawing process as a whole.

The entire disclosure of Japanese Patent Application No. 2013-161075, filed Aug. 2, 2013, No. 2013-164824, filed Aug. 8, 2013, No. 2014-118419, filed Jun. 9, 2014 and No. 2014-118420, filed Jun. 9, 2014, are expressly incorporated by reference herein.

What is claimed is:

1. A drawing device comprising:
a drawing processing unit that includes a cartridge setting unit in which a drawing liquid cartridge capable of supplying a drawing liquid to a drawing head is set in a detachable manner;
a transport unit which transports the drawing liquid cartridge between a receiving area which is any area in a vicinity of the drawing processing unit and a relay area which is any area on the cartridge setting unit side; and
a transfer unit which transfers the drawing liquid cartridge between the relay area and the cartridge setting unit.

2. The drawing device according to claim 1, further comprising:
a clean booth which accommodates the drawing processing unit, the transport unit, and the transfer unit, and maintains an internal atmosphere at a predetermined cleanliness; and
a booth opening which is provided in the clean booth and communicates with the receiving area.

3. A drawing device comprising:
a drawing processing unit that includes a cartridge setting unit in which a drawing liquid cartridge capable of supplying a drawing liquid to a drawing head is set in a detachable manner;
a clean booth which accommodates the drawing processing unit and maintains an internal atmosphere at a predetermined cleanliness;
a booth opening which is provided in the clean booth and is intended to receive the drawing liquid cartridge in the clean booth;
a transport unit which transports the drawing liquid cartridge received through the booth opening between a receiving area which is any area in a vicinity of the drawing processing unit and a relay area which is any area at the cartridge setting unit side; and
a transfer unit which transfers the drawing liquid cartridge between the relay area and the cartridge setting unit.

4. The drawing device according to claim 2,
wherein the transport unit includes:
a transport mechanism which transports the drawing liquid cartridge;
a housing which involves the receiving area and the relay area, and accommodates the transport mechanism;
an external opening/closing unit which is provided at an end portion of the booth opening side of the housing, and opens or closes the receiving area with respect to an outside of the clean booth; and
an internal opening/closing unit which is provided at an end portion of the transfer unit side of the housing, and opens or closes the relay area with respect to an inside of the clean booth.

5. The drawing device according to claim 4,
wherein the external opening/closing unit includes an external opening/closing door which opens or closes the receiving area with respect to an outside of the clean booth, and a locking mechanism which locks or unlocks the external opening/closing door in a closed state, and
the internal opening/closing unit includes an internal opening/closing door which opens or closes the relay area with respect to an inside of the clean booth, and an opening/closing mechanism which opens or closes the internal opening/closing door.

6. The drawing device according to claim 5,
wherein the transport unit further includes a transport control unit which controls the locking mechanism and the opening/closing mechanism, respectively, and
the transport control unit, by a receiving instruction, closes the internal opening/closing door, and then releases a locking of the external opening/closing door, and, by a transport instruction, locks the external opening/closing door, and then opens the internal opening/closing door.

7. The drawing device according to claim 6,
wherein the transport control unit further controls the transport mechanism, transports the drawing liquid cartridge from the relay area to the receiving area between a closing operation of the internal opening/closing door and a locking release of the external opening/closing door by the receiving instruction, and transports the drawing liquid cartridge from the receiving area to the relay area between a locking of the external opening/closing door and an opening operation of the internal opening/closing door by the transport instruction.

8. The drawing device according to claim 4,
wherein the relay area is set to be at a higher position than the receiving area in the clean booth, and
the transport mechanism ascends or descends the drawing liquid cartridge between the receiving area and the relay area.

9. The drawing device according to claim 8,
wherein the transport mechanism ascends the drawing liquid cartridge up to a position right before a top end of the drawing liquid cartridge reaches the internal opening/closing unit in the relay area.

10. The drawing device according to claim 8,
wherein the drawing liquid cartridge is mounted on a carriage in a state of being set in a set tray, and received in the receiving area, and
the transport mechanism receives the set tray from the carriage and starts a transportation of the drawing liquid cartridge in an ascending operation, and delivers the set tray to the carriage and completes the transportation of the drawing liquid cartridge in a descending operation.

11. The drawing device according to claim 4, further comprising an exhaust unit which exhausts an atmosphere in the housing to an outside of the clean booth.

12. The drawing device according to claim 11,
wherein the exhaust unit includes:
an exhaust air flow path which leads from an end portion of the booth opening side of the housing to an outside of the clean booth;
an exhaust fan which is interposed in the exhaust air flow path; and
an exhaust air control unit which controls a driving of the exhaust fan,
wherein the exhaust air control unit drives the exhaust fan when the external opening/closing unit is closed.

13. The drawing device according to claim 1,
wherein a plurality of types of the drawing liquid cartridges which have different drawing liquids are set in the cartridge setting unit,
the plurality of types of drawing liquid cartridges are transported to the relay area in a state of being set in a set tray, and
each of the drawing liquid cartridges has a detected portion for detecting a type,
the transfer unit includes:
a transfer mechanism which transfers the plurality of types of drawing liquid cartridges;
a type detector which is provided in the transfer mechanism and detects a type of the drawing liquid cartridge which is an object to be transferred through the detected portion, and
a transfer control unit which controls the transfer mechanism, and
the transfer control unit transfers the plurality of types of drawing liquid cartridges based on a result of the detection by the type detector.

14. The drawing device according to claim 13,
wherein the transfer control unit sorts the plurality of types of drawing liquid cartridges based on a type on the set tray before transferring the plurality of types of drawing liquid cartridges.

15. The drawing device according to claim 1,
wherein the drawing processing unit includes:
a table unit which moves a mounted drawing object, and
a drawing unit which is provided over the table unit and includes the drawing head and the cartridge setting unit, and performs a drawing process by discharging a drawing liquid from the drawing head while moving the drawing object using the table unit.
